(19) United States
(12) Patent Application Publication
(10) Pub. No.: US 2024/0201950 A1
(43) Pub. Date: Jun. 20, 2024

(54) NORMALIZATION IN ANALOG MEMORY-BASED NEURAL NETWORK

(71) Applicant: International Business Machines Corporation, Armonk, NY (US)

(72) Inventors: Stefano Ambrogio, San Jose, CA (US); Andrea Fasoli, San Jose, CA (US)

(21) Appl. No.: 18/081,859

(22) Filed: Dec. 15, 2022

(51) Int. Cl. G06F 7/544; G06F 7/523; G06N 3/065

(52) U.S. Cl. CPC G06F 7/5443; G06F 7/523; G06N 3/065

(57) ABSTRACT

A scale factor can be determined and applied to input values of an analog neural network implemented by a crossbar array of non-volatile memory devices. An inverse of the scale factor can be applied to synaptic weight values stored by the crossbar array of non-volatile memory devices. Operations by the crossbar array can be performed using the scaled input values and the synaptic weight values. The scale factor can be determined for each row of the crossbar array. The scale factor can be determined using a combination of the input values and the synaptic weight values.

### BACKGROUND

The present application relates generally to analog memory-based artificial neural networks and more particularly to input and weight normalization in analog memory-based artificial neural networks.

Analog memory crossbar arrays implementing multiply and accumulate (MAC) operations can accelerate performance of deep learning neural networks or deep neural networks (DNNs). For example, voltage provided as inputs to such analog memory crossbar arrays storing synaptic weights as conductance can generate current, which can represent a product or multiplication between the input vector and the synaptic weight matrix, and resulting in a multiply accumulate operation, or vector matrix multiplication. The precision achieved during a multiply-and-accumulate (MAC) operation strongly depends on the programming accuracy achieved on weights and on the input resolution. While analog neural network hardware should perform MAC operations as fast and accurately as possible, incorrect mapping of weights or too-low input resolution on hardware can lead to poor performance by the analog memory crossbar arrays. For example, encoding weights with too low a precision or too high a precision on hardware which cannot reach such values may result in inaccurate neural network outputs.

### BRIEF SUMMARY

The summary of the disclosure is given to aid understanding of input and weight normalization in analog memory-based artificial neural network, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A method, in an aspect, can include determining a scale factor. The method can also include applying the scale factor to input values of an analog neural network implemented by a crossbar array of non-volatile memory devices. The method can also include applying an inverse of the scale factor to synaptic weight values stored by the crossbar array of non-volatile memory devices.

Advantageously, the method can improve the overall precision of MAC operations, for example, performed by a crossbar array. For analog memory-based artificial neural network implemented with such crossbar arrays, the prediction accuracy can be improved.

An apparatus, in an aspect, can include a crossbar array of non-volatile memory devices configured to perform multiply and accumulate operations based on synaptic weight values of a neural network stored on the non-volatile memory devices and input values received via rows of input lines coupled to the rows of the crossbar array. The apparatus can also include a processor configured to apply a scale factor to the input values and to apply an inverse of the scale factor to the synaptic weight values stored by the crossbar array of non-volatile memory devices.

Advantageously, the apparatus can improve the overall precision of MAC operations. For analog memory-based artificial neural network implemented with such apparatus, the prediction accuracy can be improved.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating an analog-memory based neural network in an embodiment.

FIG. 2 shows a graph of different alpha values that can be selected in an embodiment.

FIG. 3A shows a distribution of original input values in an embodiment.

FIG. 3B shows a distribution of remapped input values in an embodiment.

FIG. 4 shows a block diagram of hardware where a row equalization can be performed in an embodiment.

FIG. 5 is a flow diagram illustrating a method in one embodiment.

FIG. 6A shows an example of given weight values quantized to discrete values in one embodiment.

FIG. 6B shows an example of given input values quantized to discrete values in one embodiment.

### DETAILED DESCRIPTION

Analog memory-based neural network may utilize storage capability and physical properties of memory devices such as non-volatile memory (NVM) devices to implement an artificial neural network. This type of in-memory computing hardware increases speed and energy efficiency, providing potential performance improvements. For example, rather than moving data from dynamic random access memory (DRAM) to a processor such as a central processing unit (CPU) to perform a computation, analog neural network chips perform computation in the same place where the data is stored. Because there is no movement of data, tasks can be performed faster and require less energy.

An implementation of an artificial neural network can include a succession of layers of neurons, which are interconnected so that output signals of neurons in one layer are weighted and transmitted to neurons in the next layer. A neuron Ni in a given layer may be connected to one or more neurons Nj in the next layer, and different weights wij can be associated with each neuron-neuron connection Ni-Nj for weighting signals transmitted from Ni to Nj. A neuron Nj generates output signals dependent on its accumulated inputs applied to an activation function, and weighted signals can be propagated over successive layers of the network from an input to an output neuron layer. Briefly, an activation function decides whether a neuron should be activated, or a level of activation for a neuron, for example, an output of the neuron. An artificial neural network machine learning model can undergo a training phase in which the sets of weights associated with respective neuron layers are determined. The network is exposed to a set of training data, in an iterative training scheme in which the weights are repeatedly updated as the network “learns” from the training data. The resulting trained model, with weights defined via the training operation, can be applied to perform a task based on new data.

Analog memory-based crossbar arrays or structures implementing a neural network perform parallel vector-multiply operations, with excitation vectors introduced onto multiple row-lines in order to perform multiply and accumulate operations across an entire matrix of stored weights encoded into the conductance values of analog nonvolatile resistive memories. In one or more embodiments, systems, methods and/or techniques can be provided, which can improve the weight and input resolution of the analog memory-based artificial neural network, and improve the precision of multiply and accumulate operations.

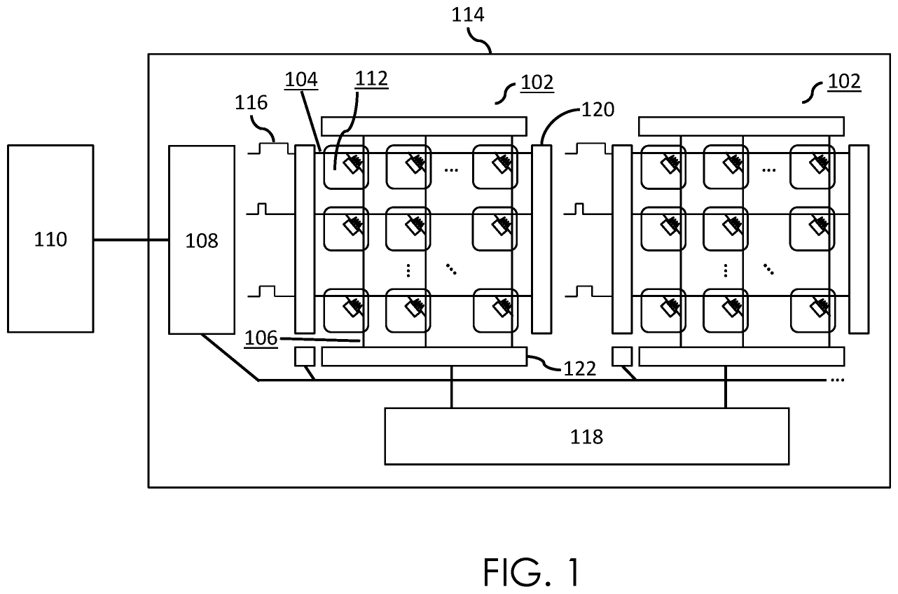

FIG. 1 is a diagram illustrating analog memory-based devices implementing a hardware neural network in an embodiment. Computational memories based on crossbar arrays (a crossbar array shown at 102 for simplicity of explanation) using electronic devices including resistive non-volatile memory (NVM) 112, can be used for artificial neural network (ANN) computations, for example, for training a deep neural network (DNN) and/or as inference accelerators for inferences with such networks. For instance, in deep learning or neural network inference, data propagation through multiple layers of a neural network involves a sequence of matrix multiplications. Each layer can be represented as a matrix of synaptic weights. These weights can be stored in the conductance states of NVM 112. These NVM 112 can be arranged in crossbar arrays, creating an artificial neural network where all matrix multiplications are performed in-place in an analog manner. For example, the arrays on the chip can directly relate to the synapse layers of the neural network. In an embodiment, for instance, a crossbar array can represent a layer of the neural network. A non-volatile memory (NVM) or NVM device (also referred to as a memristive device or technology) can maintain values stored on such a device even when the power supply is turned off. In neural network implementations, those values can represent synaptic weights or weights of a neural network.

An analog memory-based device 114 (“device 114”) is shown in FIG. 1. Device 114 can be a co-processor or an accelerator, and device 114 can sometimes be referred to as an analog fabric (AF) engine. One or more digital processors 110 can communicate with device 114, and facilitate operations or functions of device 114. In one embodiment, digital processor 110 can be a field programmable gate array (FPGA) board. Digital processor 110 can be any other digital processor. Device 114 can also be interfaced to components, such as digital-to-analog converters (DACs), that can provide power, voltage and current to device 114. Digital processor 110 can implement digital logic to interface with device 114 and other components such as the DACs.

In an embodiment, device 114 can include a plurality of multiply accumulate (MAC) hardware having a crossbar structure or array. There can be multiple crossbar structures or arrays, which can be arranged as a plurality of tiles. A crossbar array 102 of a MAC unit is also referred to as a tile. While FIG. 1 shows two MAC hardware (two tiles), there can be additional (e.g., more than two) MAC tiles integrated in device 114. By way of example, tile 102 can include electronic devices such as a plurality of memory elements 112, which for example include resistive memory. Memory elements 112 can be arranged at cross points of the crossbar array. At each cross point or junction of the crossbar structure or crossbar array, there can be at least one memory element 112 including an analog memory element such as resistive RAM (ReRAM), conductive-bridging RAM (CBRAM), NOR flash, magnetic RAM (MRAM), and phase-change memory (PCM). In an embodiment, such analog memory element can be programmed to store synaptic weights of an artificial neural network (ANN).

In an aspect, each tile 102 can represent a layer of an ANN. Each memory element 112 can be connected to a respective one of a plurality of input lines 104 and to a respective one of a plurality of output lines 106. Memory elements 112 can be arranged in an array with a constant distance between crossing points in a horizontal and vertical dimension on the surface of a substrate. Each tile 102 can perform vector-matrix multiplication. By way of example, tile 102 can include peripheral circuitry such as pulse width modulators at 120 and peripheral circuitry such as readout circuits 122. One or more peripheral circuitry connected to tile 102 or crossbar array, can scale or normalize the inputs and synaptic weights. Normalizing or normalization herein is also referred to as scaling.

Electrical pulses 116 or voltage signals can be input (or applied) to input lines 104 of a crossbar array or tile 102. Output currents can be obtained from output lines 106 of the crossbar structure, for example, according to a multiply-accumulate (MAC) operation, based on the input pulses or voltage signals 116 applied to input lines 104 and the values (synaptic weights) stored in memory elements 112. One or more peripheral circuitry connected to tile 102 or crossbar array, can function to scale or normalize the inputs and synaptic weights.

Tile 102 can include n input lines 104 and m output lines 106. A controller 108 (e.g., global controller) can program memory elements 112 to store synaptic weights values of an ANN, for example, to have electrical conductance (or resistance) representative of such values. Controller 108 can include (or can be connected to) a signal generator (not shown) to couple input signals (e.g., to apply pulse durations or voltage biases) into the input lines 104 or directly into the outputs.

In an embodiment, readout circuits 122 can be connected or coupled to read out the m output signals (electrical currents) obtained from the m output lines 106. Readout circuits 122 can be implemented by a plurality of analog-to-digital converters (ADCs). Readout circuit 122 may read currents as directly output from the crossbar array, which can be fed to another hardware or circuit 118 that can process the currents, such as performing compensations or determining errors.

Processor 110 can be configured to input (e.g., via the controller 108) a set of input vectors into the crossbar array. In one embodiment, the set of input vectors, which is input into tile 102, can be encoded as electrical pulse durations. In another embodiment, the set of input vectors, which is input into tile 102, can be encoded as voltage signals. Processor 110 can also be configured to read, via controller 108, output vectors from the plurality of output lines 106 of tile 102. The output vectors can represent outputs of operations (e.g., MAC operations) performed on the crossbar array based on the set of input vectors and the synaptic weight stored in memory elements 112. In an aspect, the input vectors get multiplied by the value (e.g., synaptic weight) stored on memory elements 112 of tile 102, and the resulting products are accumulated (added) column-wise to produce output vectors in each one of those columns (output lines 106).

In one or more embodiments, a method may provide a framework to change the input and weight mappings used in hardware neural network implementations, e.g., such that the values are more reasonably implementable by hardware devices. In an aspect, such a method preserves the sum of products Σwx, where w represents a weight value and x represents an input value. Hence the method does not change the nominal final MAC results, and therefore, the method also does not require a retraining of the neural network regardless of the changes in the input and weight values. Advantageously, the method can improve the overall precision of MAC operations.

In one or more embodiments, by scaling every input x by a factor alpha (x→alpha*x) and the corresponding weights by the same alpha, row by row (w→w/alpha), the full MAC result does not change. However, the weights which are now programmed on the tile, w/alpha, where alpha is a vector with a number of elements equal to the number of rows, can be changed in a variety of ways. As an example, weights can be remapped to adequately fit the best conductance range that the analog devices can provide, thus increasing the overall weight mapping precision.

While there are different techniques to improve weight mapping precision used in a neural network implementation, those techniques generally do not consider the inputs and weights at the same time. The method in an embodiment can provide more degrees of freedom, as, for example, have best weight remapping or best input remapping or a custom combination of both techniques.

For example, the method remaps inputs and weights in an analog tile (e.g., crossbar structure or array 102) without necessarily changing the nominal MAC, and therefore without the need to retrain the neural network. The method, in an embodiment, can include scaling inputs using a vector alpha (e.g., x→alpha*x) and the corresponding weights, row by row (w→w/alpha).

In an embodiment, a selection of the alpha vector can be done by any one or more of the following: optimizing the weight range by expanding the weights over the full dynamic range on each row; optimizing the input range by expanding the inputs over the full input dynamic range; and/or choosing a locus of points which jointly optimizes both input and weights.

Optimizing the weight range by expanding the weights over the full dynamic range on each row can include performing an operation on the weight values. For example, the scale factor alpha can be computed using a maximum of absolute values of the weight values, e.g., max(abs(W)). As another example, the scale factor alpha can be determined using a sum of the absolute values of the weight values, e.g., sum(abs(W)). The scale factors can be determined in a row-wise manner. For example, each row can have a scale factor alpha based on the values of that row.

Optimizing the input range by expanding the inputs over the full input dynamic range can include performing an operation on the weight values. For example, the scale factor alpha can be computed using a maximum of absolute values of the weight values, e.g., max(abs(W)). As another example, the scale factor alpha can be determined using a sum of the absolute values of the weight values, e.g., sum(abs(W)). The scale factors can be determined in a row-wise manner. For example, each row can have a scale factor alpha based on the values of that row.

Choosing a locus of points which jointly optimizes both input and weights can include using a combination of the input values and the weight values, for example, using both the max(abs(W)) and max(abs(X)), using both the sum(abs(W)) and sum(abs(W)).

The scale factor or factors may be determined using other computations, not limited to the above examples. Since the output Y is determined based on a multiplication (product) of X and Y, to preserve the output Y, a scale factor and an inverse of that scale factor is used on X and Y for scaling.

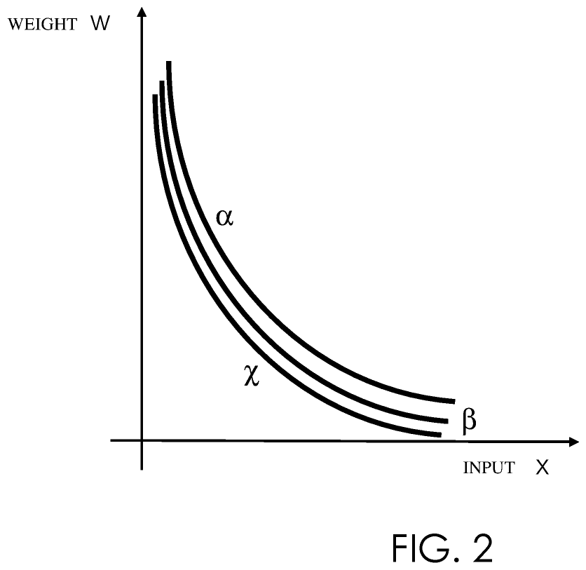

FIG. 2 shows a graph of different alpha values that can be selected in an embodiment. The graph shows correlation of weight and input values that would produce the same multiply accumulate operation result. Each curve or hyperbola can pertain to a row of input and weight values.

Consider summation of products of weight values and input values as follows, where weight matrix w and input vector x can be written as,

$$y = \sum wx = [ \begin{matrix}{w}_{00} & {w}_{01} & {w}_{02} & {w}_{03} & …\end{matrix} ] * {x}_{0} + [ \begin{matrix}{w}_{10} & {w}_{11} & {w}_{12} & {w}_{13} & …\end{matrix} ] * {x}_{1} + [ \begin{matrix}{w}_{20} & {w}_{21} & {w}_{22} & {w}_{23} & …\end{matrix} ] * {x}_{2} =$$

which can be mathematically equivalent to,

$$= α * [ \begin{matrix}{w}_{00} & {w}_{01} & {w}_{02} & {w}_{03} & …\end{matrix} ] * {x}_{0} / α + β * [ \begin{matrix}{w}_{10} & {w}_{11} & {w}_{12} & {w}_{13} & …\end{matrix} ] * {x}_{1} / β + γ [ \begin{matrix}{w}_{20} & {w}_{21} & {w}_{22} & {w}_{23} & …\end{matrix} ] * {x}_{2} / γ$$

where every row of the weight matrix w is multiplied as a coefficient alpha and the corresponding input is divided by the coefficient alpha, e.g.,

$$= ( alpha . * w ) * ( x . / alpha )$$

The above expression can apply to all values of alpha (α), beta (β) and gamma (γ), e.g., every row of multiplication. Alpha (α), beta (β), gamma (γ), and so forth for another row, are also referred to herein as alphas, alpha vector, or a vector of alphas (where the vector includes multiple scaling factors, each for a row).

In the above formula, the subscripts used to represent weight value (w) represent indices of neurons in consecutive layers of a neural network. For example, wᵢⱼ represents a synaptic weight of a neuron to neuron connection between i-th neuron of a layer and j-th neuron of a next layer in a neural network. The subscript used to represent input value (x) represents an index associated with an input value, e.g., as in a vector of input values, for example, different feature values used as input to a neural network, also referred to as rows of input values.

The method can change alpha by exploring the hyperbola, which includes loci of points of weighs and input values, mathematically giving the exact same MAC. A hyperbola shows a correlation between a certain input x and certain weight w. Any points selected from the hyperbola or curve would result in the same multiply accumulate result. Each curve or hyperbola can pertain to a row of input and weight values. Different rows can have different hyperbolae. For example, if the weight matrix and input vectors are of 512 rows, there can be 512 hyperbolae. In an embodiment, alpha (α), beta (β), and gamma (γ) values that provide the best representation in terms of noise and/or quantization can be selected.

Choosing and using a normalization or scaling factor (e.g., alpha, beta, gamma) can move or transform the weight and input values from extreme regions into values or regions that are more manageable or easier to work with on the hardware. For example, changing the scaling factor moves the weight and input values along the hyperbola.

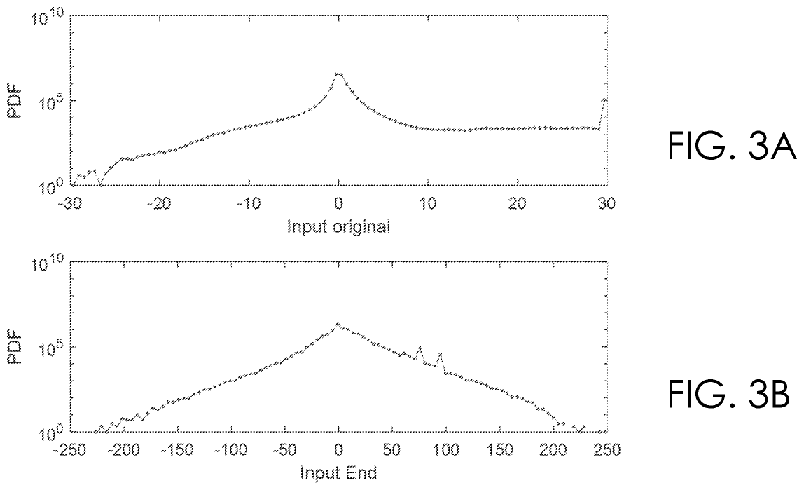

FIG. 3A shows a distribution of original input values. FIG. 3B shows a distribution of remapped input values. By rescaling weights and inputs, the method can change the input distribution, getting a more hardware-friendly final distribution. For instance, original input values may have too small of a precision or too large of a precision where the values would not be easy to implement on hardware. Normalizing or scaling the input values using a scale factor (also referred to as a coefficient) remaps the distribution density of the input values. The remapped input density distribution can be easier to implement on hardware. In an aspect, the scale factor for remapping can be chosen based on a particular hardware material's characteristics, and its capacity or efficiency in processing certain range of values (e.g., voltage, conductance, resistivity).

In an embodiment, normalization can include applying an n-bit quantization to both weight (W) and input (X) matrices and vectors. Quantization is a process of discretizing a distribution of values (i.e., approximate the original, high-precision values using few discrete values). Quantization may introduce some error (quantization error) in the distributions of W, X, and Y=WX.

In an embodiment, the method may estimate the quantization error by computing a root mean square error (rmse). In an embodiment, the method may use quantization error as a proxy for analog error (where the lower error indicates the better performance of the neural network). The method may track how rmse varies when equalization is applied to W and X, which are scaled row-wise (row-wise from a hardware perspective) using a common row-equalization factor alpha (α).

In an embodiment, the factor alpha (a) can be computed as a combination of row-wise max(abs(W)) and row-wise(max(abs(X)). In another embodiment, the factor alpha (α) can be computed solely from W, as row-wise max(abs(W)). Yet in another embodiment, the factor alpha (α) can be computed solely from X, as row-wise max(abs(X)).

Results show that a combined equalization reduces error on Y. Alpha (α) computed based solely on W or X reduces error on the single matrix (respective W or X). Another benefit is that analog hardware need not deal with extreme low or high values in W and X.

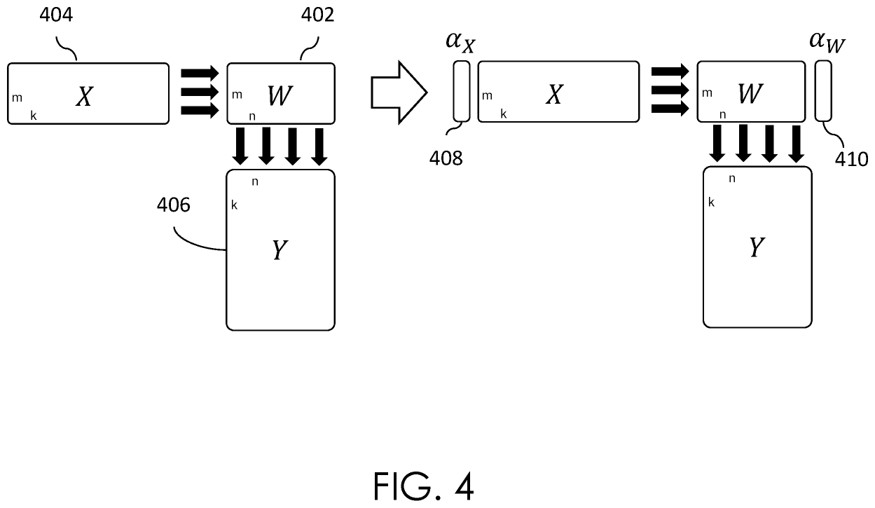

FIG. 4 shows a block diagram of hardware where a row equalization can be performed in an embodiment. A crossbar array or a MAC tile can store a m-by-n matrix of weights (W) as shown at 402 (e.g., where n represents a number of neurons in a layer, and m represents a number of inputs connecting to each neuron). Input vectors (X) as shown at 404 can be of m-by-k dimension, e.g., where m represents the number of input features (rows of input), and k represents k number of such input features, for example, a batch of k input samples. Multiply and accumulate operations performed on the crossbar array based on the matrix of weights 402 and the input vectors 404 produce outputs of n-by-k dimensions 406 (e.g., for each neuron in n neurons, k number of outputs corresponding to k number of inputs).

In an embodiment, row equalization can be performed which includes scaling W and X row-wise (in hardware perspective) by a common factor α (where α is a vector of length m, i.e., one value per row). This row equalization preserves the output Y 406 but changes the range of multiply and accumulate (MAC) operands, W and X. Row equalization allows for avoiding programming of too high or too low W and X, that is, make those values more favorable for analog hardware. Using α, row equalization also allows to minimize noise error on hardware. For example, the method may scale X by α_{X} 408 and W by α_{W} 410, where α_{X} and α_{w} are vectors, one value per row, where α_{X}=1/α_{W}. To preserve output Y, a common α for W and X are used, where a scale factor and an inverse of that same scale factor would be used on W and X. In an embodiment, the method may determine the common α.

In an embodiment, for determining the scaling factor «, quantization may be performed, which models noise with approximation into a given weight and input distribution. For example, given a distribution of weight values and input values, a method in an aspect can add some noise to the given distribution of weights and input values, and move the distributions with different scaling factor alphas, determining how the noise on the output changes based on the different scaling factor alpha. A scaling factor alpha that minimizes the noise on the output resulting from the quantization can be chosen. For example, a quantization method or framework can provide a potential proxy for analog noise and can derive a strategy to minimize error by finding a good or optimal α that provides minimum error. Here error to be minimized is the difference between the output resulting from the given weight and input distributions and the output resulting from the quantized weight and input distributions.

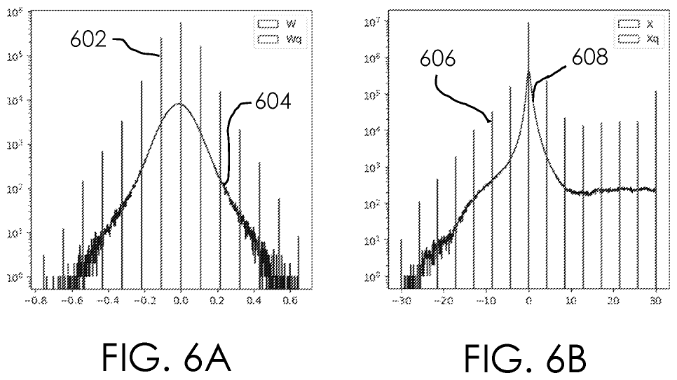

In an embodiment, quantization may use fewer values for weights and inputs. For example, weight values can be grouped into bins (e.g., 16 weight values (bins)) to represent a given weight value distribution. In an aspect, such quantization may transform original values having uniform continuous distribution to discrete distribution. For example, in an aspect, the weight and/or input values can be constrained to fewer values. FIG. 6A shows given weight values quantized to discrete values. For instance, the vertical lines 602 show bins into which a range of values are grouped. The continuous line 604 shows a given original distribution of weight values. Similar quantization can be performed for the input value distribution. FIG. 6B shows given input values quantized to discrete values. For instance, the vertical lines 606 show bins into which a range of values are grouped. The continuous line 608 shows a given original distribution of input values.

In an aspect, this quantization can introduce or add noise or model noise into the weight and input distributions. Such added error can act as a proxy for analog noise in hardware. An objective can be to minimize this quantization error. For example, if output has a low quantization error, then it can be presumed that the output in the analog hardware can also be minimized. To minimize the quantization error, the method can track the root mean square error to measure error as the method applies different row equalization using different alphas. The alpha value (e.g., for each row) that minimizes such output error can be chosen or selected. For example, different alphas can be selected using different operators such as, but not limited to, using information from the weight values only, using information from the input values only, and using information from both the weight values and input values, for example, as described above.

In an embodiment, for any given matrix M, α can be calculated using operators such as max(abs(M)) or sum(abs(M)), for example, row-wise. Max (or maximum) operator gives importance to the extremes, while sum (or summation) operator emphasizes importance to the intensity of the whole row.

For example:

$${α}_{Xi} = \frac{1}{max ( \vert {X}_{i} \vert )} .$$

In this example, α is determined per row i, and based on the input values (X) of that row i. Similarly, another example would be to use the sum operator, e.g., as in

$${α}_{Xi} = \frac{1}{sum ( \vert {X}_{i} \vert )} .$$

As another example:

$${α}_{Wi} = \frac{1}{max ( \vert {W}_{i} \vert )} .$$

In this example, α is determined per row i, and based on the weight values (W) of that row i. Similarly, another example would be to use the sum operator, e.g., as in

$${α}_{Wi} = \frac{1}{sum ( \vert {W}_{i} \vert )} .$$

Yet as another example, a combined equalization can be used, where both the weight and input values are used in determining the α value. For example, a ratio of the two values can be used as a scaling factor. For example:

$${α}^{*} = \sqrt{\frac{{α}_{W}}{{α}_{X}}} .$$

For example, the scaling factor in this example is determined as a square root of a ratio of information from the weight distribution and the input distribution. Such combined equalization can be done on a per row basis, e.g., row i.

Once an alpha value for that row is determined, that alpha value can be applied to the weights in that row and an inverse of that same alpha value can be applied to the input value corresponding to that row.

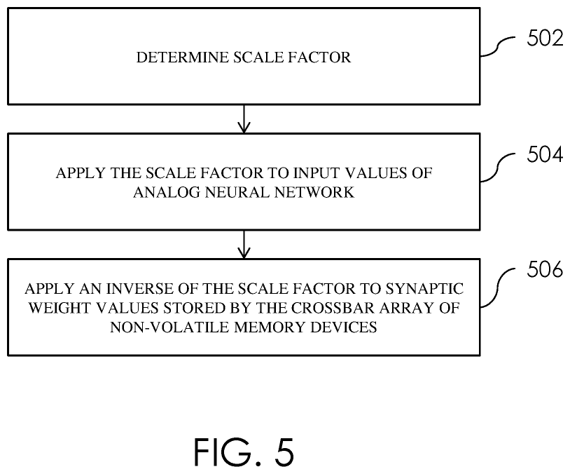

FIG. 5 is a flow diagram illustrating a method in one embodiment. In an embodiment, the method can be performed by a peripheral circuitry connected to or coupled to a crossbar array. In another embodiment, a digital processor such as a field programmable gate array or another processor (for example, shown in FIG. 1 at 110) may perform the method. For example, local digital cores can perform input scaling, and weight scaling can be predetermined before weight programming. At 502, a scale factor is determined, for example, as described above. At 504, the scale factor can be applied to input values of an analog neural network implemented by a crossbar array of non-volatile memory devices. At 506, an inverse of the scale factor can be applied to synaptic weight values stored by the crossbar array of non-volatile memory devices.

In an embodiment, the scale factor can be determined for each row of the crossbar array. In an embodiment, the scale factor can be determined using a maximum of absolute values of synaptic weight values stored on a row of the crossbar array. In another embodiment, the scale factor can be determined using a maximum of absolute values of input values being applied to a row of the crossbar array. In yet another embodiment, the scale factor can be determined using a combination of a maximum of absolute values of synaptic weight values stored on a row of the crossbar array and a maximum of absolute values of input values being applied to the row of the crossbar array.

In another embodiment, the scale factor can be determined using a sum of absolute values of synaptic weight values stored on a row of the crossbar array. In still another embodiment, the scale factor can be determined using a sum of absolute values of input values being applied to a row of the crossbar array. Yet in another embodiment, the scale factor can be determined using a combination of a sum of absolute values of synaptic weight values stored on a row of the crossbar array and a sum of absolute values of input values being applied to the row of the crossbar array.

The method can be used in any analog hardware, for example, that implements a neural network. The method, for example, rearranges a given distribution of weights and given distribution of inputs so that the values become more manageable or implementable on hardware, while preserving (not changing) the expected results. For instance, some hardware may not have the capacity to reach certain values (e.g., too large or too small). In an aspect, the method moves the weight and input values to a region of values where there is less noise in hardware processing those values. The method may find the normalization factor or scaling factor that moves the weight and input values into regions of distribution, where the hardware may efficiently perform its functions (e.g., in a minimum noise region).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a scale factor;
applying the scale factor to input values of an analog neural network implemented by a crossbar array of non-volatile memory devices; and
applying an inverse of the scale factor to synaptic weight values stored by the crossbar array of non-volatile memory devices.

2. The method of claim 1, wherein the scale factor is determined for each row of the crossbar array.

3. The method of claim 2, wherein the scale factor is determined using a maximum of absolute values of synaptic weight values stored on a row of the crossbar array.

4. The method of claim 2, wherein the scale factor is determined using a maximum of absolute values of input values being applied to a row of the crossbar array.

5. The method of claim 2, wherein the scale factor is determined using a combination of a maximum of absolute values of synaptic weight values stored on a row of the crossbar array and a maximum of absolute values of input values being applied to the row of the crossbar array.

6. The method of claim 2, wherein the scale factor is determined using a sum of absolute values of synaptic weight values stored on a row of the crossbar array.

7. The method of claim 2, wherein the scale factor is determined using a sum of absolute values of input values being applied to a row of the crossbar array.

8. The method of claim 2, wherein the scale factor is determined using a combination of a sum of absolute values of synaptic weight values stored on a row of the crossbar array and a sum of absolute values of input values being applied to the row of the crossbar array.

9. An apparatus comprising:
a crossbar array of non-volatile memory devices configured to perform multiply and accumulate operations based on synaptic weight values of a neural network stored on the non-volatile memory devices and input values received via rows of input lines coupled to the rows of the crossbar array; and
a processor configured to apply a scale factor to the input values and to apply an inverse of the scale factor to the synaptic weight values stored by the crossbar array of non-volatile memory devices.

10. The apparatus of claim 9, wherein the processor is configured to determine the scale factor for each row of the crossbar array.

11. The apparatus of claim 10, wherein the scale factor is determined using a maximum of absolute values of synaptic weight values stored on a row of the crossbar array.

12. The apparatus of claim 10, wherein the scale factor is determined using a maximum of absolute values of input values being applied to a row of the crossbar array.

13. The apparatus of claim 10, wherein the scale factor is determined using a combination of a maximum of absolute values of synaptic weight values stored on a row of the crossbar array and a maximum of absolute values of input values being applied to the row of the crossbar array.

14. The apparatus of claim 10, wherein the scale factor is determined using a sum of absolute values of synaptic weight values stored on a row of the crossbar array.

15. The apparatus of claim 10, wherein the scale factor is determined using a sum of absolute values of input values being applied to a row of the crossbar array.

16. The apparatus of claim 10, wherein the scale factor is determined using a combination of a sum of absolute values of synaptic weight values stored on a row of the crossbar array and a sum of absolute values of input values being applied to the row of the crossbar array.

17. A computer program product comprising a computer readable storage medium having program instructions embodied therewith, the program instructions readable by a device to cause the device to:
determine a scale factor;
apply the scale factor to input values of an analog neural network implemented by a crossbar array of non-volatile memory devices; and
apply an inverse of the scale factor to weight values stored by the crossbar array of non-volatile memory devices.

18. The computer program product of claim 17, the scale factor is determined for each row of the crossbar array.

19. The computer program product of claim 18, wherein the scale factor is determined using a combination of a maximum of absolute values of synaptic weight values stored on a row of the crossbar array and a maximum of absolute values of input values being applied to the row of the crossbar array

20. The computer program product of claim 18, wherein the scale factor is determined using a combination of a sum of absolute values of synaptic weight values stored on a row of the crossbar array and a sum of absolute values of input values being applied to the row of the crossbar array.
